(19) United States
(12) Patent Application Publication
(10) Pub. No.: US 2004/0052395 A1
(43) Pub. Date: Mar. 18, 2004

(54) Microphone protection cover

(76) Inventor: Chang Ab Sin, Seoul (KR)

Correspondence Address: LADAS & PARRY, 224 SOUTH MICHIGAN AVENUE, SUITE 1200, CHICAGO, IL, 60604, US

(21) Appl. No.: 10/654,036

(22) Filed: Sep. 3, 2003

(30) Foreign Application Priority Data
Sep. 16, 2002 (KR) KR20-2002-0027816

(51) Int. Cl. H04R 9/08; H04R 19/04; H04R 3/00

(52) U.S. Cl. 381/361; 381/122

(57) ABSTRACT

A microphone protection cover is provided, which surrounds the outer surface of a microphone. The microphone protection cover protects a connector. Also, the microphone protection cover includes a tension absorber therein, to thereby absorb and disperse a tensile force generated when a microphone cable is pulled in an instant, and prevent the microphone cable from being cut or shorted. Accordingly, the performance and life of the microphone can be enhanced. The microphone protection cover which protects a connector which is connected on the lower end of the microphone and a microphone cable, includes a cover body which is installed in the form of surrounding the microphone to protect the microphone and the microphone cable, and a tension absorber including an end cap which is installed at the inner end of the cover body, and includes an opening through which the microphone cable passes, a stopper which is fixed to the microphone cable at a predetermined distance from the end cap, and a spring which is positioned between the stopper and the end cap, and absorbs a tensile force generated when the microphone cable is pulled instantaneously.

### BACKGROUND OF THE INVENTION

1. Field of the Invention

The present invention relates to a microphone protection cover, and more particularly, to a microphone protection cover which prevents degradation of connection of a connector which connects a microphone with a microphone cable, and prevents the microphone cable from being cut or shorted at the connection portion between the microphone and the microphone cable.

2. Description of the Related Art

In general, a microphone receives sound waves or ultrasound waves and generates electrical signals according to the vibration due to the sound waves or ultrasound waves. In a conventional microphone shown in FIG. 1, a connector 2 through which a microphone cable 3 is connected is simply combined with the lower end of the microphone 1.

However, if a number of persons use the microphone frequently, the connection state between the connector 2 and the microphone cable 3 is degraded, to thereby cause inferior connection. Also, if the microphone cable 3 is pulled in a moment, the microphone cable 3 can be cut or shorted by the pulling force at the lower end of the microphone connector 2.

### SUMMARY OF THE INVENTION

To solve the above problems, it is an object of the present invention to provide a microphone protection cover which surrounds the outer surface of a microphone, to thereby protect a connector, and which includes a tension absorber therein, to thereby absorb and disperse a tensile force generated when a microphone cable is pulled in an instant, and prevent the microphone cable from being cut or shorted.

To accomplish the above object of the present invention, there is provided a microphone protection cover which protects a connector which is connected on the lower end of the microphone and a microphone cable, comprising: a cover body which is installed in the form of surrounding the microphone to protect the microphone and the microphone cable; and a tension absorber including an end cap which is installed at the inner end of the cover body, an opening through which the microphone cable passes, a stopper which is fixed to the microphone cable at a predetermined distance from the end cap, and a spring which is positioned between the stopper and the end cap, and absorbs a tensile force generated when the microphone cable is pulled instantaneously.

### BRIEF DESCRIPTION OF THE DRAWINGS

The above object and other advantages of the present invention will become more apparent by describing the preferred embodiment thereof in more detail with reference to the accompanying drawings in which:

FIG. 1 is a front view showing a conventional microphone;

FIG. 2 is a sectional view showing a state where a microphone protection cover according to the present invention is combined with a microphone;

FIG. 3 is a front view showing a state where a microphone protection cover according to the present invention is combined with a microphone; and

FIG. 4 is a perspective view showing a tension absorber which is mounted in the microphone protection cover according to the present invention.

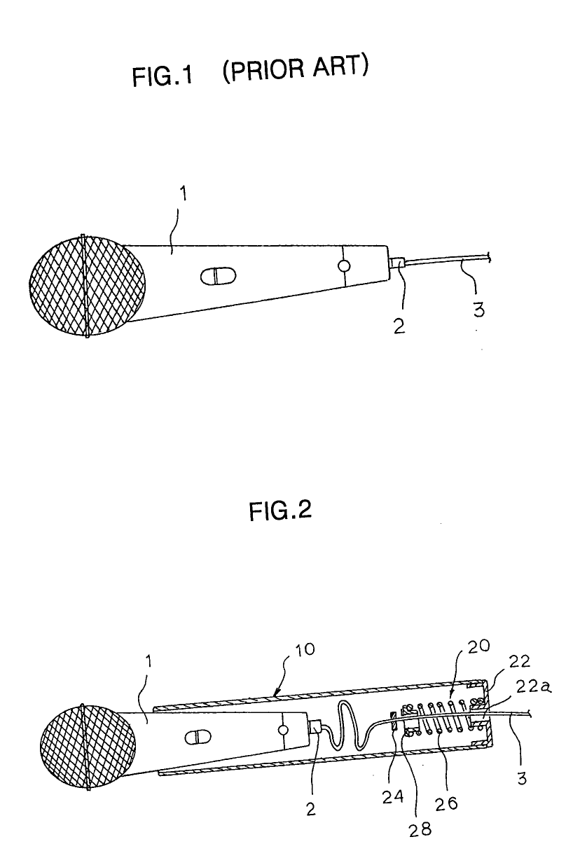

### DETAILED DESCRIPTION OF THE INVENTION

A preferred embodiment of the present invention will be described with reference to the accompanying drawings.

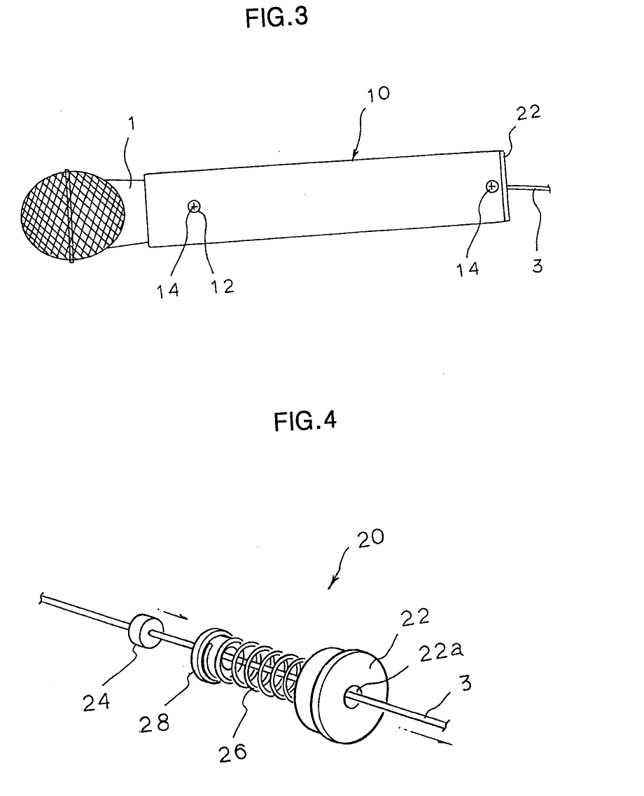

Referring to FIGS. 2 through 4, a microphone protection cover according to the present invention includes a cover body 10 which is installed in the form of surrounding a microphone 1 to protect the microphone 1 and a microphone cable 3. A connection hole 12 is formed on the cover body 10. The cover body 10 is fixed to the microphone 1 by a screw 14. The number of connection holes may be determined as an appropriate number by a designer, according to a physical condition of the microphone.

As shown, the microphone protection cover according to the present invention includes a tension absorber 20. The tension absorber 20 is installed in the cover body 10, to absorb a tensile force generated when the microphone cable 3 is pulled instantaneously, to thereby prevent the microphone cable 3 from being cut or shorted.

The tension absorber 20 includes an end cap 22 which is installed at the inner end of the cover body 10, an opening 22a through which the microphone cable 3 passes, a stopper 24 which is fixed to the microphone cable 3 at a predetermined distance from the end cap 22, and a spring 26 which is positioned between the stopper 24 and the end cap 22, and absorbs a tensile force generated when the microphone cable 3 is pulled in a moment. A supporting piece 28 is installed at the end of the spring 26 positioned toward the stopper 24, to thereby enable the spring 26 to perform a smooth action with respect to the stopper 24.

In the microphone protection cover shown in FIG. 2 according to the present invention, the microphone cable 3 is contained with a sufficient length in the cover body 10. This is to make the tension absorber 20 take actions when the microphone cable 3 is pulled excessively.

If the microphone cable 3 is pulled in an instant in the above-described tension absorber 20, the stopper 24 fixed to the microphone cable 3 is pulled together with the microphone cable 3. In this case, as soon as the stopper 24 contacts the supporting piece 28 combined with the one end of the spring 26, the spring 26 starts an action of contraction, to accordingly absorb a tensile force generated in the microphone cable 3 to prevent the microphone cable 3 from being cut or shorted.

The microphone combined with the microphone protection cover according to the present invention, encloses a connector and protects the same, to thereby remove a cause of degradation of connection between the microphone and the microphone cable.

Also, since a tension absorber including an end cap, a stopper and a spring is installed in the microphone protection cover according to the present invention, a tensile force generated when a microphone cable is pulled instantaneously can be absorbed or dispersed. Accordingly, since a force applied to the connector and the microphone cable can be minimized, the microphone cable can be prevented from being cut or shorted even although the microphone cable is pulled in a moment.

As described above, the microphone protection cover according to the present invention protects the microphone performance and prevents the microphone cable from being cut or shorted as well. Accordingly the microphone protection cover according to the present invention can be applied to microphones for business places which a number of persons use.

As described above, when a microphone protection cover according to the present invention is combined with a microphone, performance of the microphone can be protected and a microphone cable can be prevented from being cut or shorted. As a result, the life of the microphone can be extended. Also, since the microphone cable is prevented from being cut or shorted, a cost for replacement of the microphone cable can be saved.

As described above, the present invention has been described with respect to a particularly preferred embodiment. However, the present invention is not limited to the above embodiment, and it is possible for one who has an ordinary skill in the art to make various modifications and variations, without departing off the spirit of the present invention.

What is claimed is:

1. A microphone protection cover which protects a connector which is connected on the lower end of the microphone and a microphone cable, the microphone protection cover comprising:
a cover body which is installed in the form of surrounding the microphone to protect the microphone and the microphone cable; and
a tension absorber including an end cap which is installed at the inner end of the cover body, an opening through which the microphone cable passes, a stopper which is fixed to the microphone cable at a predetermined distance from the end cap, and a spring which is positioned between the stopper and the end cap, and absorbs a tensile force generated when the microphone cable is pulled instantaneously.
